(19) United States
(12) Patent Application Publication
(10) Pub. No.: US 2015/0106812 A1
(43) Pub. Date: Apr. 16, 2015

(54) CLOUD GATEWAY, CLOUD GATEWAY MANAGEMENT DEVICE, AND METHOD THEREOF

(71) Applicant: POWER-ALL NETWORKS LIMITED, Shatin (HK)

(72) Inventor: STEVE LAP WAI HUI, Shatin (HK)

(21) Appl. No.: 14/511,361

(22) Filed: Oct. 10, 2014

(30) Foreign Application Priority Data
Oct. 16, 2013 (CN) 201310482085.7

(51) Int. Cl. G06F 9/455; H04L 12/24

(52) U.S. Cl. CPC G06F 9/45533; H04L 41/0806
USPC 718/1

(57) ABSTRACT

A cloud gateway management method includes: receiving a creation request for creating a cloud gateway from a user; creating a cloud gateway when the request receiving module receives the creation request, wherein the cloud gateway is a format of a virtual machine; generating a plurality of virtual network cards in the cloud gateway, each virtual network card being used to connect to a corresponding network; assigning a corresponding network address for each virtual network card; and configuring the cloud gateway according to network configuration information including the network address of each virtual network card.

### CROSS-REFERENCE TO RELATED APPLICATIONS

This application claims priority to Chinese Patent Application No. 201310482085.7 filed on Oct. 16, 2013, the contents of which are incorporated by reference herein.

### FIELD

The present disclosure relates to management devices, and particularly to a cloud gateway, a cloud gateway management device, and a method thereof.

### BACKGROUND

Usually, when a user accesses a network source, such as emails, videos provided by an Internet service provider (ISP) via an electronic device, such as a tablet computer, a mobile phone, the electronic device should first connect to the Internet, then connect to an ISP intranet of the ISP via the Internet. Therefore, the electronic device must have the capability of accessing the Internet. In some situations, when the number of people accessing the network is great and when the electronic device connects to networks according to a certain network bandwidth assigned by a corresponding network operator, the access speed may become very slow.

### BRIEF DESCRIPTION OF THE DRAWINGS

Implementations of the present technology will now be described, by way of example only, with reference to the attached figures.

FIG. 1 is a block diagram of a cloud gateway management device.

FIG. 2 is a diagrammatic view of a cloud gateway connected to different networks.

FIG. 3 is a flowchart diagram of an embodiment of a cloud gateway management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected.

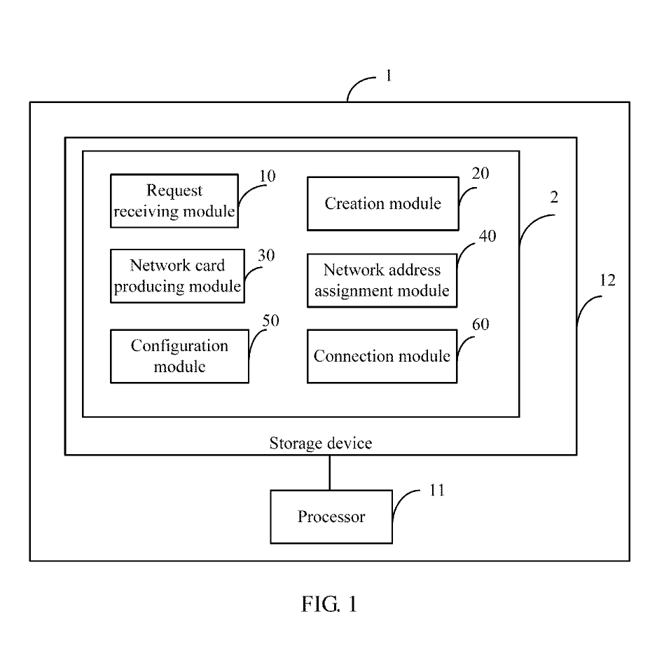

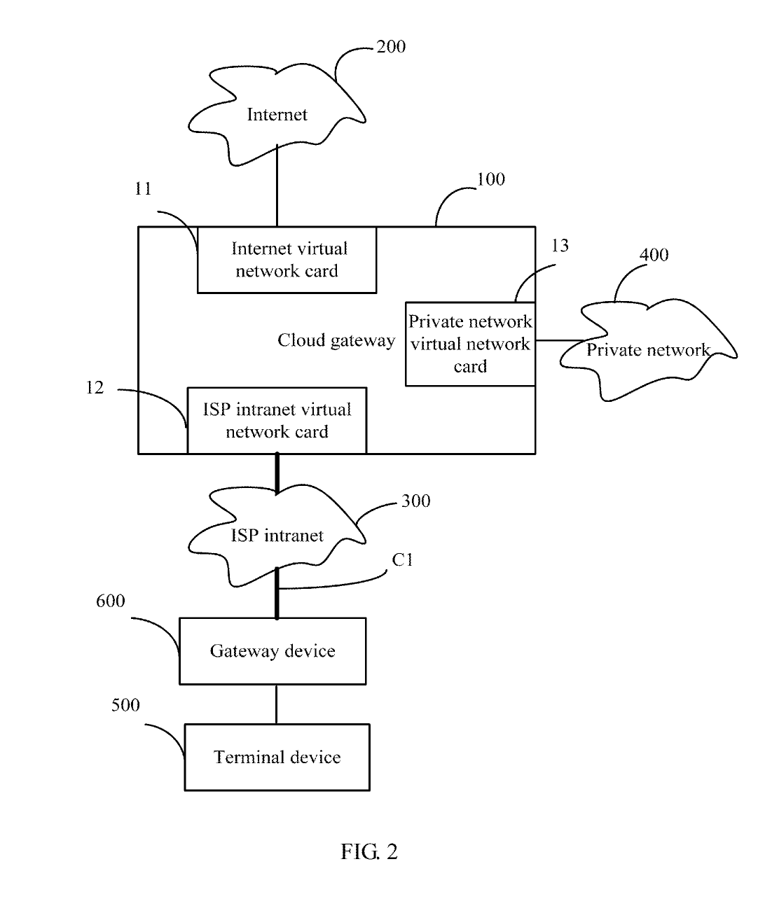

Referring to FIGS. 1 and 2, a cloud gateway management device 1 for establishing and configuring a cloud gateway 100 as shown in FIG. 2 is illustrated. The cloud gateway management device 1 includes at least one processor 11 and at least one storage device 12.

A cloud gateway management system 2 is stored in the storage device 12 and executed by the processor 11. The cloud gateway management system 2 includes a request receiving module 10, a creation module 20, a network card generating module 30, a network address assignment module 40, a configuration module 50, and a connection module 60. The modules of the cloud gateway management system can be a collection of software instructions stored in the storage device 12 and executed by the processor 11, or can include functionality represented as hardware or integrated circuits, or as software and hardware combinations, such as a special-purpose processor or a general-purpose processor with special-purpose firmware.

In one embodiment, the processor 11 can be a central processing unit, a digital signal processor, or a single chip, for example. In one embodiment, the storage device 12 can be an internal storage system, such as a flash memory, a random access memory (RAM) for temporary storage of information, and/or a read-only memory (ROM) for permanent storage of information. The storage device 12 can also be a storage system, such as a hard disk, a storage card, or a data storage medium. The storage device 12 can include volatile and/or non-volatile storage devices. In at least one embodiment, the storage device 12 can include two or more storage devices such that one storage device is a memory and the other storage device is a hard drive. Additionally, one or more of the storage devices 12 can be located either entirely or partially external relative to the cloud gateway management device 1.

The request receiving module 10 is used to receive a creation request for creating a cloud gateway from a user. In detail, the user can access a webpage provided by the cloud gateway management device 1 to submit the creation request.

The creation module 20 is used to create a cloud gateway 100 when the request receiving module 10 receives the creation request from the user. In the embodiment, the cloud gateway 100 is a virtual cloud gateway, and can be a virtual machine (VM).

The network card generating module 30 is used to generate a number of virtual network cards in the cloud gateway 100, each virtual network card is used to connect to a corresponding network.

As shown in FIG. 2, in the embodiment, the virtual network cards include an Internet virtual network card 11, an Internet service provider (ISP) intranet virtual network card 12, and a private network virtual network card 13. The Internet virtual network card 11 is used to connect to an Internet 200 and can be used to access the Internet 200. The ISP intranet virtual network card 12 is used to connect to an ISP intranet 300 and can be used to access the ISP intranet 300. The private network virtual network card 13 is used to connect to a private network 400 and can be used to access the private network 400.

The ISP intranet 300 is a network provided by an ISP operator. The ISP intranet 300 can provide a number of data source, such as videos, audio files, news, and the like. In the embodiment, the terminal device 500 connecting to the same ISP intranet 300 can directly access the ISP intranet 300 without the Internet 200. For example, the ISP intranet 300 can be a network established by an enterprise to which the user belongs, thus, the user can access the ISP intranet 300 directly, without need to access the ISP intranet 300 via the Internet 200.

The network address assignment module 40 can assign a corresponding network address for each virtual network card. In the embodiment, the network address is an internet protocol (IP) address. In another embodiment, the network address assignment module 40 further can assign a corresponding bandwidth for each virtual network card.

The configuration module 50 can configure the cloud gateway 100 according to network configuration information including the network address of each virtual network card.

The connection module 60 can receive an access request for accessing the cloud gateway 100, and establish a channel C1 for connecting to the cloud gateway 100 via the ISP intranet 300 and the ISP intranet virtual network card 12 of the cloud gateway 100 when receiving the access request. In detail, the user can first connect a gateway device 600 located in an area (such as an office or a family) to the ISP intranet 300, and access a management interface provided by the gateway device 600 to input the network address, such as the IP address of the ISP intranet virtual network card 12 of the cloud gateway 100. Accordingly, the connection module 60 connects the gateway device 600 to the ISP intranet 300 in response to the user operation, such as an operation of inputting the network address via the management interface provided by the gateway device 600. The connection module 60 further establishes the channel C1 passing through the ISP intranet 300 and the ISP intranet virtual network card 12 of the cloud gateway 100 and between the gateway device 600 and the cloud gateway 100 according to the network address of the ISP intranet virtual network card 12 input via the management interface of the gateway device 600.

Thus, when the user connects a terminal device 500 to the gateway device 600, the terminal device 500 can connect to the ISP intranet 300 and the virtual ISP intranet virtual network card 12 via the gateway device 600, and then connect to the cloud gateway 100. In other words, the cloud gateway 100 is connected to the ISP intranet 300 via the ISP intranet virtual network card 12, and is connected to a gateway device 600 via the ISP intranet 300, and then is connected to the at least one terminal device 500 connected to the gateway device 600 via the gateway device 600.

In the embodiment, the gateway device 600 can be a router located in the office or the family, the terminal device 500 can be a mobile phone, or a computer, such as a tablet computers, a portable computers, a desktop computer, for example.

In the embodiment, the cloud gateway 100 can start up the Internet virtual network card 11 when the user requests to access the Internet 200 via the terminal device 500. Then, terminal device 500 can access the Internet 200 via the Internet virtual network card 11 of the cloud gateway 100. The cloud gateway 100 further can start up the private network virtual network card 13 when the user requests to access the private network 400 via the terminal device 500. Then, terminal device 500 can access the private network 400 via the private network virtual network card 13 of the cloud gateway 100. Therefore, when the terminal device 500 is connected to the cloud gateway 100, the terminal device 500 further can access the Internet 200 via the Internet virtual network card 11 or access the private network 400 via the private network virtual network card 13. In the embodiment, the ISP intranet virtual network card 12 is kept in a worked-on state, thus to enable the connection between the gateway device 600 and the cloud gateway 100 via the ISP intranet virtual network card 12 and the ISP intranet 300 is established always.

When the cloud gateway 100 receives a data access request for accessing a target data from the terminal device 500 of the user, the cloud gateway 100 determines whether the

ISP intranet 300 or the private network 400 can provide the target data. If the ISP intranet 300 or the private network 400 can provide the target data, the cloud gateway 100 controls the terminal device 500 to access the target data provided by the ISP intranet 300 or the private network 400. If the ISP intranet 300 and the private network 400 both cannot provide the data, the cloud gateway 100 starts up the Internet virtual network card 11, and controls the terminal device 500 to connect to the Internet 200 via the Internet virtual network card 11, thus to access the target data provided by the Internet 200.

In detail, the cloud gateway 100 transmits the data access request to an address analysis module (not shown). The data access request includes information of the data, the information of the data can be a name for the target data, a keyword of the target data, or a network address of the target data. The information of the data also can be any combination of the name for the target data, the keyword of the target data, and the network address of the target data. The address analysis module searches the target data from the ISP intranet 300 or the private network 400 according to the information of the data. The address analysis module determines whether the ISP intranet 300 or the private network 400 can provide the target data by determining whether the target data is searched from the ISP intranet 300 or the private network 400. For example, the address analysis module determines the ISP intranet 300 or the private network 400 can provide the target data when determining the target data is searched from the ISP intranet 300 or the private network 400. As described above, the cloud gateway 100 controls the terminal device 500 to access the data provided by the ISP intranet 300 or the private network 400 when the ISP intranet 300 or the private network 400 can provide the target data.

When the address analysis module determines the ISP intranet 300 and the private network 400 both cannot provide the target data, the cloud gateway 100 starts up the Internet virtual network card 11, the address analysis module further searches the target data from the Internet 200, thus to provide the target data to the user via the Internet 200. In the embodiment, the address analysis module is configured outside of the cloud gateway 100, such as, the address analysis module can be programmable software installed in an analysis server (not shown). In other embodiments, the address analysis module can be programmable software installed in the cloud gateway 100.

In another embodiment, the private network 400 can combine the cloud gateway 100 to constitute a private cloud.

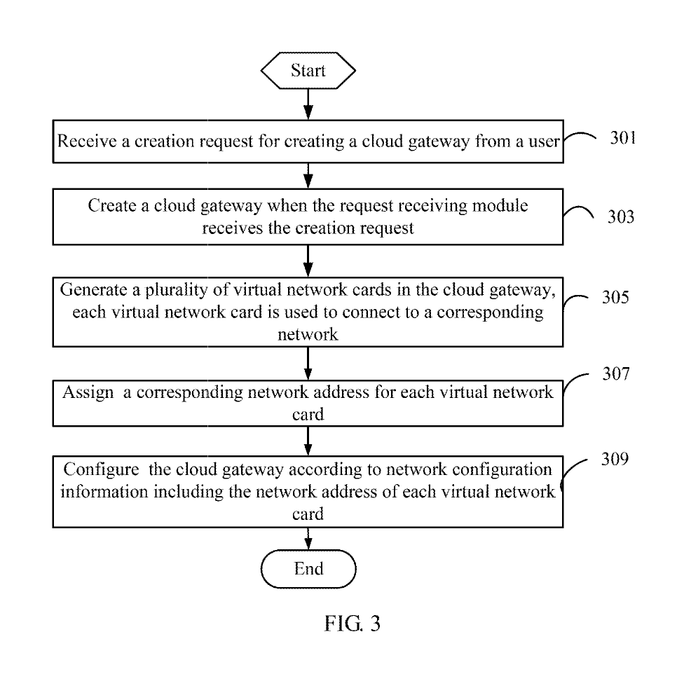

FIG. 3 illustrates a flowchart of the cloud gateway management method. The method is provided by way of example, as there are a variety of ways to carry out the method. The method described below can be carried out using the configurations illustrated in FIG. 1, for example, and various elements of these figures are referenced in explaining the example method. Each block shown in FIG. 3 represents one or more processes, methods, or subroutines carried out in the example method. Additionally, the illustrated order of blocks is by example only and the order of the blocks can be changed. The example method can begin at block 301.

In block 301, a request receiving module receives a creation request for creating a cloud gateway from a user. In detail, the user can access a webpage provided by the cloud gateway management device to submit the creation request.

In block 303, a creation module creates a cloud gateway when the request receiving module receives the creation request from the user. In the embodiment, the cloud gateway is a format of a virtual machine (VM).

In block 305, a network card generating module generates a number of virtual network card in the cloud gateway, each virtual network card is used to connect to a corresponding network. In detail, the virtual network cards include an Internet virtual network card, an ISP intranet virtual network card, and a private network virtual network card. The Internet virtual network card is used to connect to an Internet and can be used to access the Internet. The ISP intranet virtual network card is used to connect to an ISP intranet and can be used to access the ISP intranet. The private network virtual network card is used to connect to a private network and can be used to access the private network.

In block 307, a network address assignment module assigns a corresponding network address for each virtual network card.

In block 309, a configuration module configures the cloud gateway according to network configuration information including the network address of each virtual network card.

In the embodiment, the cloud gateway management method can further include: a connection module receives an access request for accessing the cloud gateway, and establishes a channel for connecting to the cloud gateway via the ISP intranet and the ISP intranet virtual network card of the cloud gateway when receiving the access request.

The cloud gateway management method can further include: the cloud gateway starts up the Internet virtual network card 11 when the user requests to access the Internet via a terminal device.

The cloud gateway management method can further include: the cloud gateway starts up the private network virtual network card when the user requests to access the private network via the terminal device 500.

The cloud gateway management method can further include: when the cloud gateway receives a data access request for accessing a target data from the terminal device of the user, the cloud gateway determines whether the ISP intranet or the private network can provide the target data; if the ISP intranet or the private network can provide the target data, the cloud gateway controls the terminal device to access the target data provided by the ISP intranet or the private network; if the ISP intranet and the private network both cannot provide the data, the cloud gateway starts up the Internet virtual network card, and controls the terminal device to connect to the Internet via the Internet virtual network card, thus to access the target data provided by the Internet.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A cloud gateway management device comprising:
a storage device configured to store a plurality of modules which are collections of instructions; and
at least one processor configured to execute the plurality of modules which are collections of instructions, the modules comprising:
a request receiving module configured to receive a creation request for creating a cloud gateway from a user;
a creation module configured to create a cloud gateway when the request receiving module receives the creation request, wherein the cloud gateway is a virtual machine;
a network card generating module configured to generate a plurality of virtual network cards in the cloud gateway, each virtual network card being used to connect to a corresponding network;
a network address assignment module configured to assign a corresponding network address for each virtual network card; and
a configuration module configured to configure the cloud gateway according to network configuration information including the network address of each virtual network card.

2. The device according to claim 1, wherein the plurality of virtual network cards comprise an Internet virtual network card, an Internet service provider (ISP) intranet virtual network card, and a private network virtual network card; the Internet virtual network card is configured to connect to an Internet; the ISP intranet virtual network card is configured to connect to an ISP intranet; the private network virtual network card is configured to connect to a private network.

3. The device according to claim 2, wherein the modules further comprise a connection module configured to receive an access request for accessing the cloud gateway, and establish a channel for connecting to the cloud gateway via the ISP intranet and the ISP intranet virtual network card of the cloud gateway when receiving the access request.

4. The device according to claim 3, wherein the connection module connects a gateway device located in an area to the ISP intranet in response to user operation, and establishes the channel passing through the ISP intranet and the ISP intranet virtual network card of the cloud gateway and between the gateway device and the cloud gateway according to a network address of the ISP intranet virtual network card of the cloud gateway input via a management interface of the gateway device.

5. The device according to claim 1, wherein the corresponding network address for each virtual network card is an Internet protocol address of each virtual network card.

6. The device according to claim 1, wherein the network address assignment module is further configured to assign a corresponding bandwidth for each virtual network card.

7. A cloud gateway, configured to connect to different networks, the cloud gateway comprising:
an Internet virtual network card, configured to connect to an Internet;
an Internet service provider (ISP) intranet virtual network card configured to connect to an ISP intranet; and
a private network virtual network card configured to connect to a private network.

8. The cloud gateway according to claim 7, wherein the cloud gateway is configured to connect to the ISP intranet via the ISP intranet virtual network card, and connect to a gateway device via the ISP intranet, and then connect to at least one terminal device connected to the gateway device via the gateway device.

9. The cloud gateway according to claim 8, wherein when the cloud gateway receives a data access request for accessing a target data from the terminal device of a user, the cloud gateway determines whether the ISP intranet or the private network can provide the target data; if the ISP intranet or the private network can provide the target data, the cloud gateway controls the terminal device to access the target data provided by the ISP intranet or the private network; if the ISP intranet and the private network both cannot provide the data, the cloud gateway starts up the Internet virtual network card, and controls the terminal device to connect to the Internet via the Internet virtual network card, thus to access the target data provided by the Internet.

10. The cloud gateway according to claim 8, wherein, the cloud gateway starts up the Internet virtual network card when the user requests to access the Internet via the terminal device; and starts up the private network virtual network card when the user requests to access the private network via the terminal device.

11. A cloud gateway management method comprising:
receiving a creation request for creating a cloud gateway from a user;
creating a cloud gateway when the request receiving module receives the creation request, wherein the cloud gateway is a virtual machine;
generating a plurality of virtual network cards in the cloud gateway, each virtual network card being used to connect to a corresponding network;
assigning a corresponding network address for each virtual network card; and
configuring the cloud gateway according to network configuration information including the network address of each virtual network card.

12. The method according to claim 11, wherein the step of generating a plurality of virtual network cards in the cloud gateway comprising:
generating an Internet virtual network card configured to connect to an Internet;
generating an Internet service provider (ISP) intranet virtual network card configured to connect to an ISP intranet; and
generating a private network virtual network card configured to connect to a private network.

13. The method according to claim 12, further comprising:
receiving an access request for accessing the cloud gateway; and
establishing a channel for connecting to the cloud gateway via the ISP intranet and the ISP intranet virtual network card of the cloud gateway when receiving the access request.

14. The method according to claim 13, wherein the step of establishing a channel for connecting to the cloud gateway via the ISP intranet and the ISP intranet virtual network card of the cloud gateway when receiving the access request comprising:
connecting a gateway device located in an area to the ISP intranet in response to user operation; and
establishing the channel passing through the ISP intranet and the ISP intranet virtual network card of the cloud gateway and between the gateway device and the cloud gateway according to a network address of the ISP intranet virtual network card of the cloud gateway input via a management interface of the gateway device.

15. The method according to claim 11, wherein the corresponding network address for each virtual network card is an Internet protocol address of each virtual network card.

16. The method according to claim 11, further comprising:
assigning a corresponding bandwidth for each virtual network card.
